(19) United States
(12) Patent Application Publication
(10) Pub. No.: US 2015/0158047 A1
(43) Pub. Date: Jun. 11, 2015

(54) ADJUSTABLE HEIGHT SHOWER SYSTEM

(71) Applicant: MASCO CORPORATION OF INDIANA, Indianapolis, IN (US)

(72) Inventors: Brian Wayne Johnson, Muncie, IN (US); Paul V. Patton, Indianapolis, IN (US); Anthony G. Spangler, Indianapolis, IN (US); Daniel S. Genord, South Lyon, MI (US)

(73) Assignee: MASCO CORPORATION OF INDIANA, Indianapolis, IN (US)

(21) Appl. No.: 14/099,230

(22) Filed: Dec. 6, 2013

(51) Int. Cl. B05B 15/08; B05B 1/18

(52) U.S. Cl. CPC B05B 15/08; B05B 1/185

(57) ABSTRACT

An adjustable shower system including a support tube configured to be fluidly coupled to a shower arm, and a main body supported for sliding movement along the support tube. A shower head is supported by the main body and is fluidly coupled to the support tube. A brake is configured to releasably secure the main body at one of a plurality vertical positions along the support tube.

### BACKGROUND AND SUMMARY

The present disclosure relates generally to shower heads and, more particularly, to an adjustable height shower system including a shower head vertically adjustable along a support tube.

Conventional fixed shower heads are typically not configured to accommodate users of different heights. If the shower head is positioned for a tall person, a shorter bather may have to stand further away to be in the path of the spray. If the shower head is positioned for a short person, a taller person may have to crouch to get beneath the spray. As such, it is desirable to have a shower system that would allow a shower head to be vertically adjusted to accommodate bathers of different heights. It would also be advantageous for such a system to include an integrated locking mechanism, positioned within reach of users of different heights, to facilitate lowering the shower head when the shower head is positioned too high for a user to reach.

The present disclosure relates to a shower system including a main body having a sliding tube assembly that attaches to a pre-existing shower arm in a wall and supports a shower head. The sliding tube assembly allows the user to adjust the vertical position of the main body. The desired position is illustratively maintained by an internal friction brake. Depressing a button located proximate the lower front of the main body disengages the brake, allowing for vertical adjustment of the shower head. Releasing the button reengages the brake, locking the shower head in a desired vertical position. In certain illustrative embodiments, both a fixed overhead shower head and a hand shower may be supported by the main body.

According to an illustrative embodiment of the present disclosure, an adjustable shower system includes a support tube configured to be fluidly coupled to a shower arm. A main body is supported for sliding movement along the support tube, the main body including an inlet, a first outlet and a second outlet. A shower head is fluidly coupled to the first outlet. A hand shower includes a flexible outlet tube fluidly coupled to the second outlet. A diverter valve is supported by the main body and is configured to provide selective fluid communication between the inlet and the first outlet, and the inlet and the second outlet. The main body includes a riser tube in fluid communication with the support tube, the riser tube being positioned in a telescoping arrangement with the support tube and in fluid communication with the inlet and the diverter valve.

According to another illustrative embodiment, an adjustable shower system includes a support tube configured to be fluidly coupled to a shower arm. A riser tube is fluidly coupled to the support tube and supported for sliding movement along the support tube. A shower head is fluidly coupled to the riser tube. A brake is configured to releasably secure the riser tube at one of a plurality of vertical positions along the support tube. The brake includes a user interface, a brake plate, and a release arm operably coupling the user interface and the brake plate. The user interface is configured to cause the release arm to move the brake plate from a locked position secured to the support tube to an unlocked position released from the support tube.

According to further illustrative embodiment of the present disclosure, an adjustable shower system includes a support tube configured to be fluidly coupled to a shower arm. A main body is supported for a sliding movement along the support tube. A shower head is fluidly coupled to the main body, and a hand shower includes a flexible outlet tube is fluidly coupled to the main body. A cradle is supported by the main body and is configured to releasably support the hand shower. A brake is configured to releasably secure the main body at one of a plurality of vertical positions along the support tube.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a perspective view of an illustrative embodiment adjustable height shower system of the present disclosure, including a main body supporting a shower head;

FIG. 2 is a perspective view of an further illustrative embodiment adjustable height shower system of the present disclosure, including a main body supporting a shower head and a hand shower;

FIG. 3 is a side elevational view of the shower system of FIG. 2;

FIG. 4 is a partially exploded perspective view of the shower system of FIG. 2;

FIG. 5 is an exploded perspective view of a user interface assembly of the shower system of FIG. 2;

FIG. 6 is a detailed perspective view showing an illustrative tube guide positioned above an outer housing of the main body of FIG. 4;

FIG. 7A is a cross-sectional view of the shower system of FIG. 2, showing the main body in a raised position;

FIG. 7B is a cross-sectional view similar to FIG. 7A, showing the main body in a lowered position;

FIG. 8A is a bottom perspective view of the shower system showing the hand shower cradle in a first position;

FIG. 8B is a view similar to FIG. 8A showing the hand shower cradle rotated to a second position;

FIG. 9 is an exploded perspective view of the diverter valve of FIG. 5;

FIG. 10A is a perspective view showing the diverter valve lever in a first position;

FIG. 10B is a perspective view showing the diverter valve lever rotated to a second position;

FIG. 11A is a cross-sectional view showing the diverter valve in the first position of FIG. 10A;

FIG. 11B is a cross-sectional view showing the diverter valve in the second position of FIG. 10B;

FIG. 12 is a perspective view of the brake assembly of the present disclosure;

FIG. 13A is a side elevational view showing the brake assembly in a first or engaged position;

FIG. 13B is a side elevational view showing the brake assembly in a second or released position;

FIG. 14A is a detailed cross-sectional view showing the brake plate in the engaged position of FIG. 13A; and

FIG. 14B is a cross-sectional view showing the brake plate in the released position of FIG. 13B.

### DETAILED DESCRIPTION OF THE DRAWINGS

The embodiments of the invention described herein are non-intended to be exhaustive or to limit the invention through precise forms disclosed. Rather, the embodiments elected for the description had been chose to enable one skilled in the art to practice the invention.

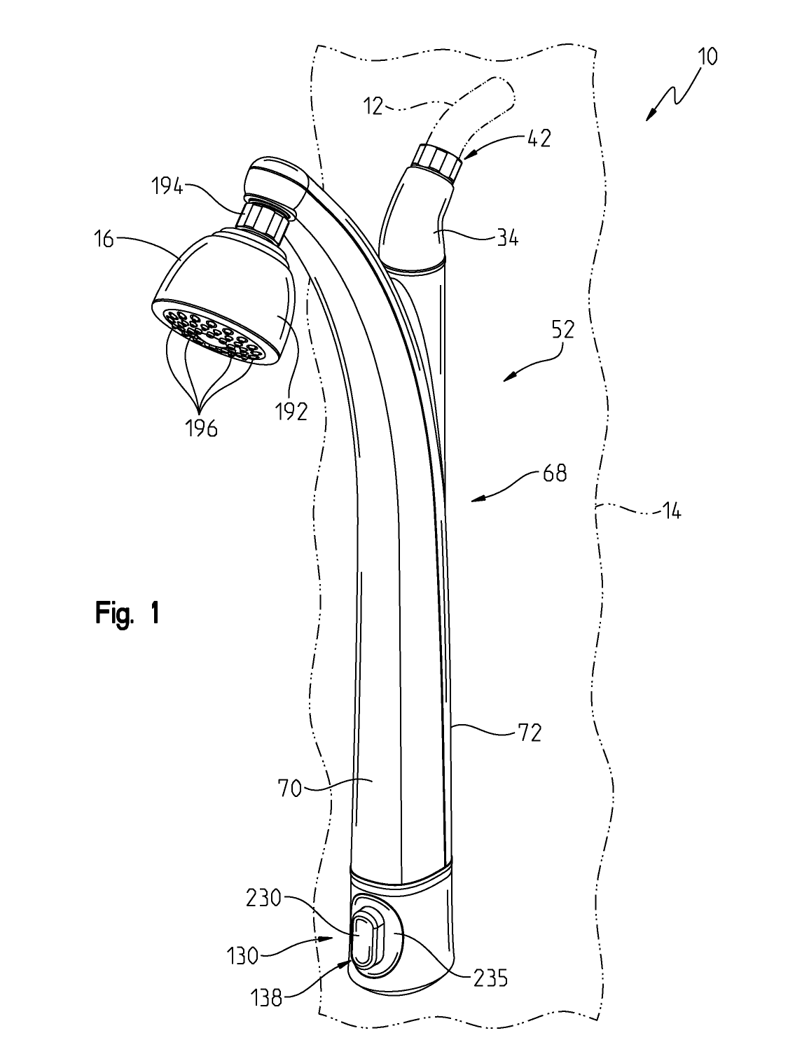

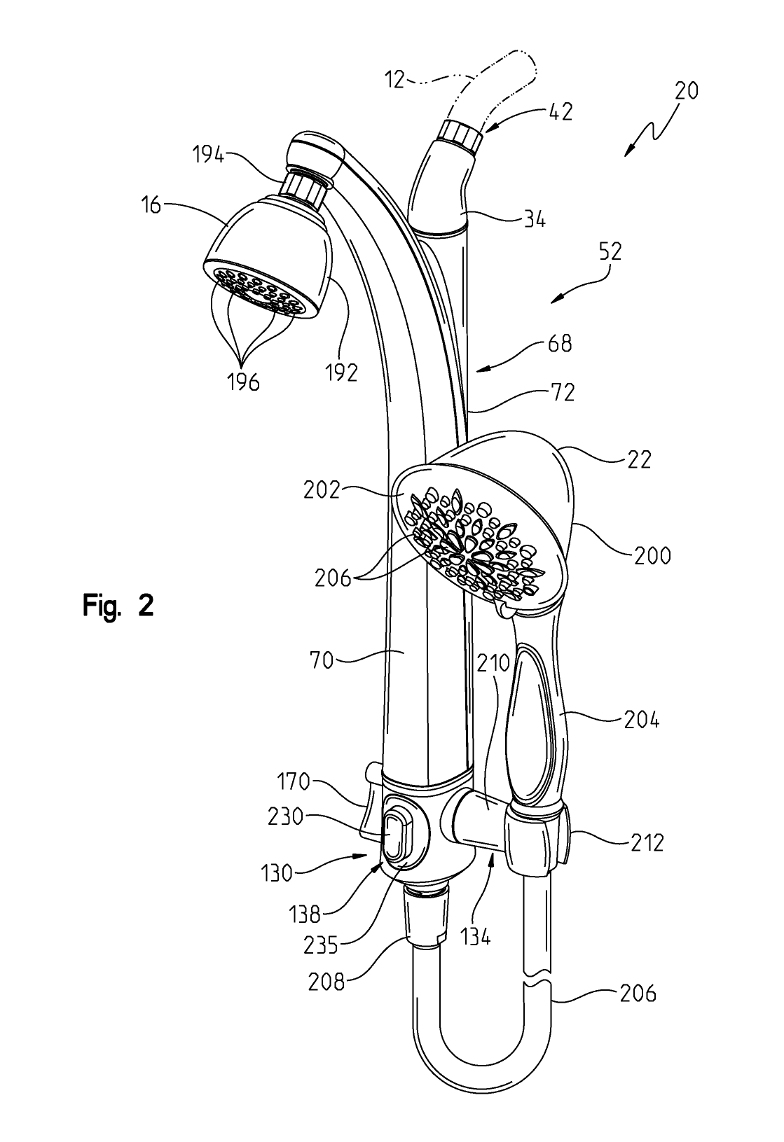

Referring initially to FIG. 1, an illustrative shower system 10 of the present disclosure is shown for coupling to a conventional shower arm 12 extending from a shower wall 14. The illustrative embodiment shower system 10 of FIG. 1 includes a single overhead shower head 16, while the illustrative embodiment shower system 20 of FIG. 2 includes both shower head 16 and a hand shower 22. It should be appreciated that any number or type of fluid outlets may be used with the shower system 10, 20 of the present disclosure. Given the similarities of the embodiments, the following detailed description will focus on the shower system 20 of FIG. 2 including both shower head 16 and hand shower 22.

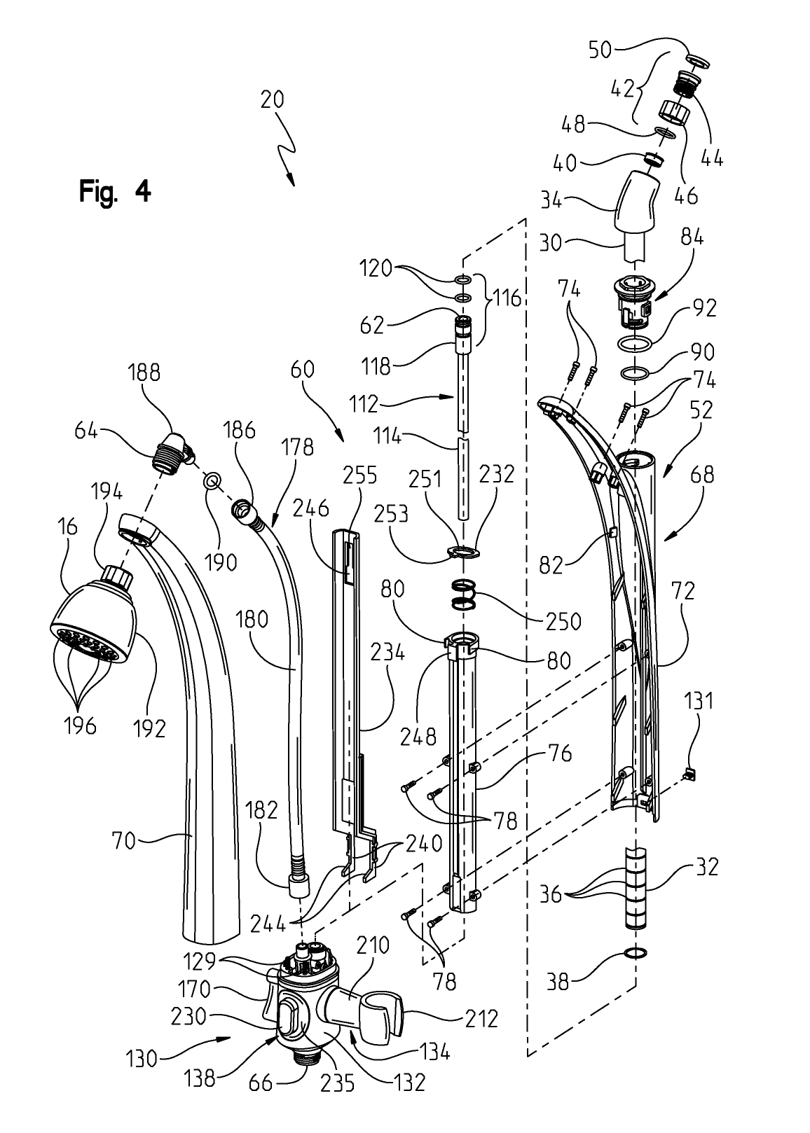

With reference to FIGS. 2-5, the shower system 20 illustratively includes a support tube 30 configured to be fluidly coupled to the shower arm 12 which, in turn, is coupled to a water supply through a control valve (not shown). The support tube 30 illustratively includes a cylindrical main tube 32 having an upper end fluidly coupled to an elbow 34. A lower end of the main tube 32 includes a plurality of longitudinally spaced annular grooves 36 (FIG. 4). A snap ring 38 is configured to be received within one of the grooves 36 to define a lower limit stop, as further detailed herein.

A flow restrictor 40 may be received within the elbow 34. A fluid connector 42 includes a cylindrical adapter 44 cooperating with an internally threaded nut 46. An o-ring 48 seals the connector 42 within the elbow 34. The nut 46 of connector 42 is configured to threadably couple with the external threads of shower arm 12. A face seal 50 is illustratively positioned intermediate the adapter 44 and the shower arm 12.

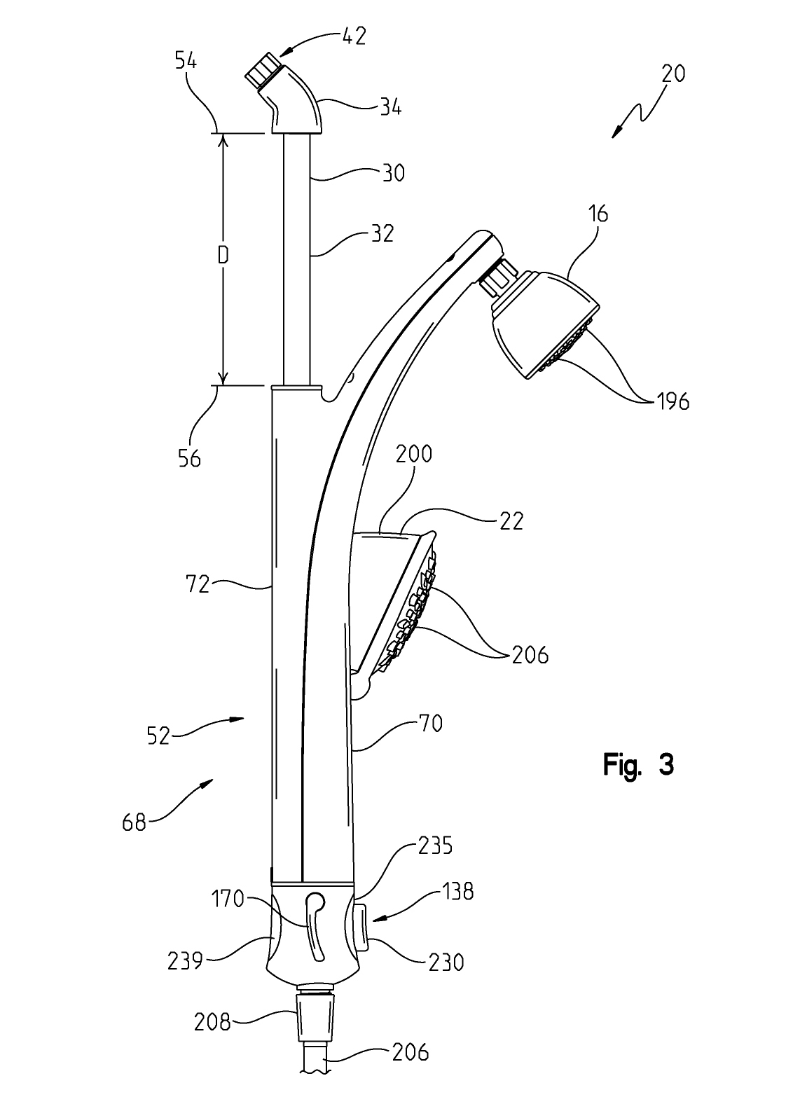

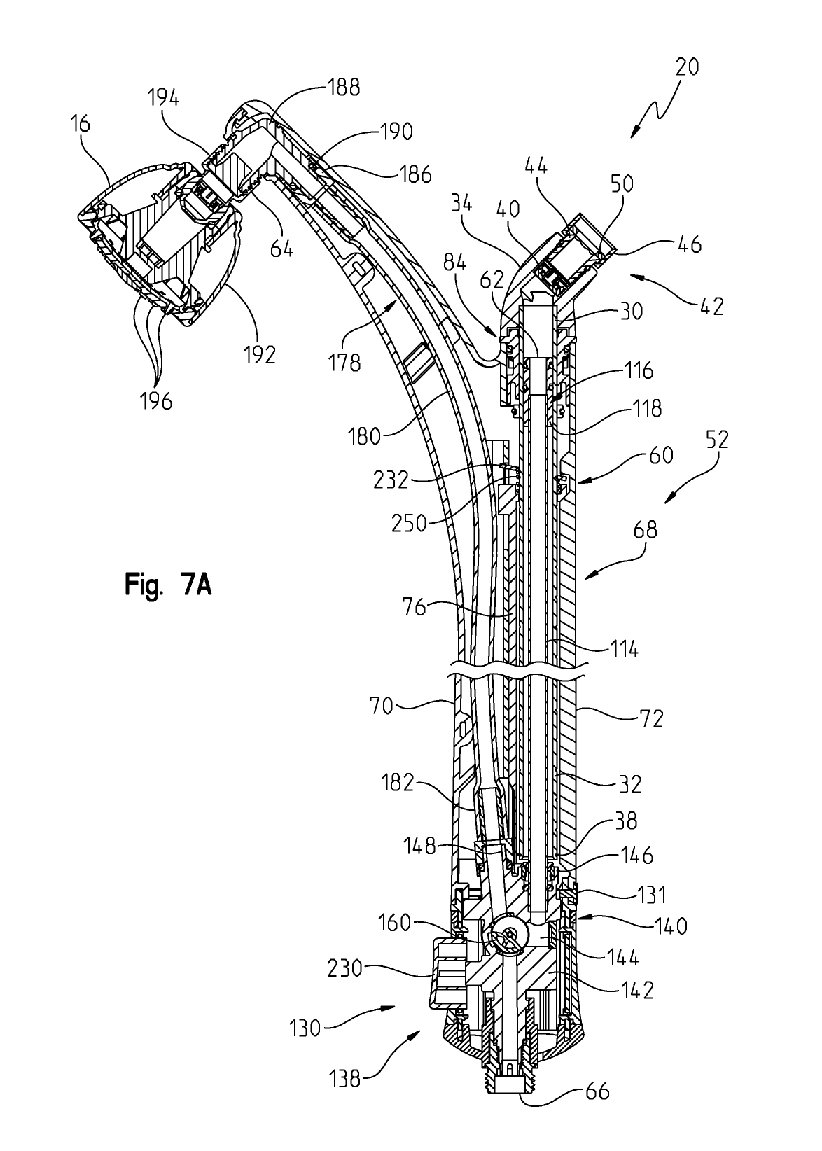

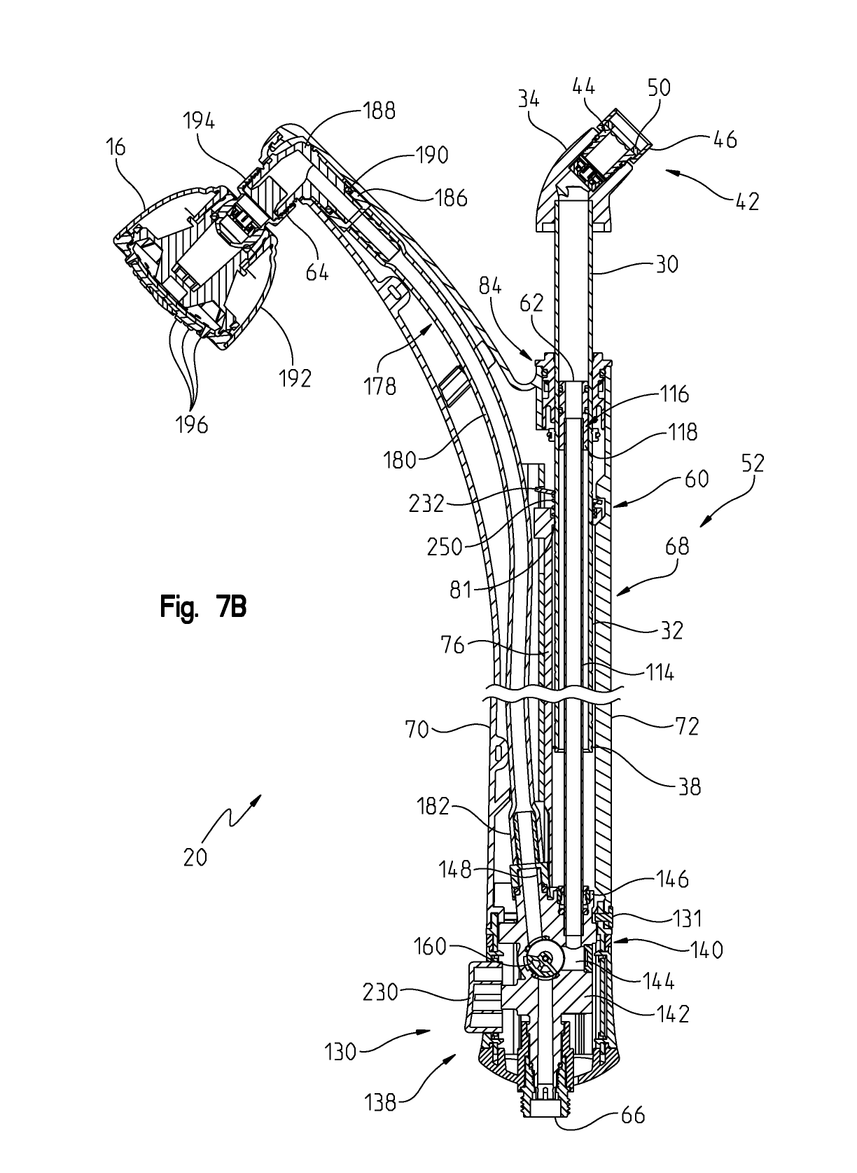

With further reference to FIG. 3, a main body 52 is supported by the support tube 30 and is configured to slideably move along the support tube 30 between an upper limit position 54 (FIG. 7A) and a lower limit position 56 (FIG. 7B). In the illustrative embodiment, the distance D between upper and lower limit positions 54 and 56 is approximately 9 inches. A brake 60 is configured to secure or lock the main body 52 (and thereby the shower head 16 and the hand shower 22) at a desired vertical position between upper and lower limit positions 54 and 56.

The main body 52 includes an inlet 62, a first outlet 64 and a second outlet 66. The inlet 62 is in fluid communication with the support tube 30. The first outlet 64 is in fluid communication with the shower head 16, and the second outlet 66 is in fluid communication with the hand shower 22.

The main body 52 includes an outer housing 68 having a front housing 70 coupled to a rear housing 72, illustratively through conventional fasteners, such as screws 74. A cylindrical tube support 76 is received within the outer housing 68 and is illustratively secured to the rear housing 72 through conventional fasteners, such as screws 78. The tube support 76 receives the support tube 30 and may slidably move relative to the support tube 30. The tube support 76 supports and retrains the support tube 30. A pair of snap fingers 80 on the tube support 76 may engage ramped protrusions 82 on the rear housing 72 to provide an additional coupling between the tube support 76 and the outer housing 68.

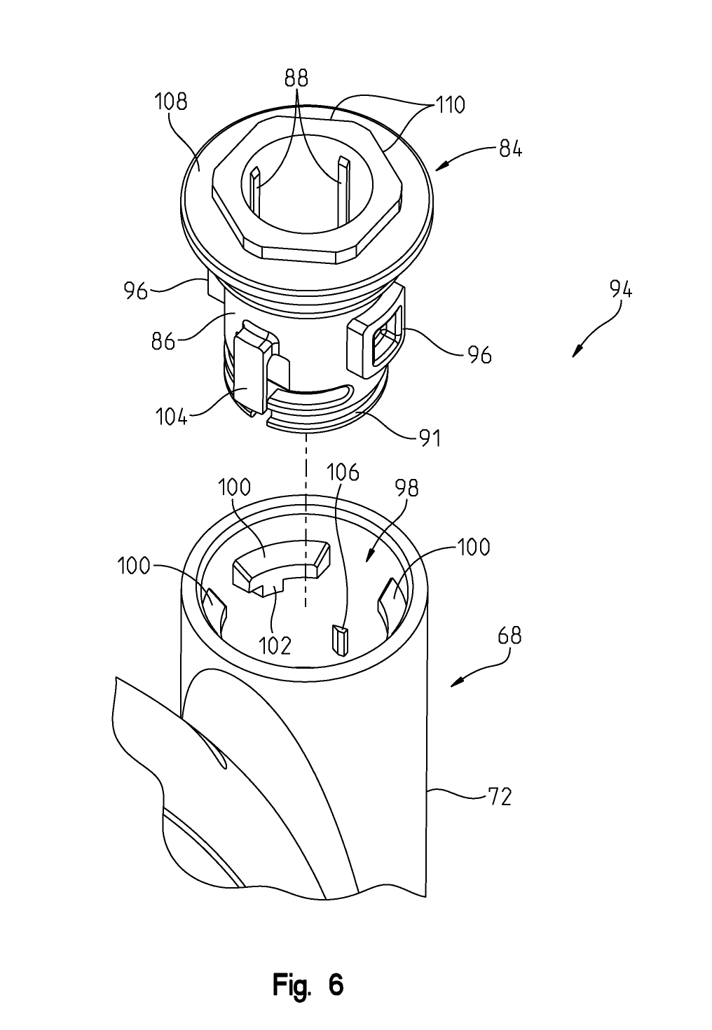

With reference to FIGS. 4 and 6, a tube guide 84 is supported by an upper end of the outer housing 68 and slidably receives the support tube 30. The tube guide 84 includes a body 86 having an inner surface supporting longitudinally extending ribs 88 configured to slidably contact the support tube 30. An inner o-ring 90 is illustratively received within an annular channel 91 within a split portion on the lower end of the tube guide 84 to squeeze onto the support tube 30, thereby creating a controlled drag on the tube 30. An outer o-ring 92 is illustratively received between the tube guide 84 and the outer housing 68 to provide a seal therebetween.

Referring further to FIG. 6, a bayonet coupling 94 illustratively secures the tube guide 84 to the outer housing 68. More particularly, diametrically opposed guide tabs 96 of the tube guide 84 are moved axially through slots 98 defined between arcuate flanges 100 of the outer housing 68. The guide tabs 96 are then illustratively rotated clockwise into position below the flanges 100 to first stops 102 to axially lock the tube guide 84, and rotationally lock the tube guide 84 from rotation in a first direction (illustratively clockwise). Diametrically opposed flexible fingers 104 of the tube guide 84 pass over ramped protrusions 106 of the outer housing 68 to lock the tube guide 84 from rotation in a second direction (illustratively counter-clockwise). The body 86 of tube guide 84 further includes a flange 108 that extends above the outer housing 68 and may define an upper limit stop by engaging the elbow 34. Tool engagement elements, illustratively a plurality of flats 110 are supported above the flange 108 and facilitate assembly of the tube guide 84 within the rear housing 72.

With respect to FIGS. 4, 7A and 7B, a riser or diverter tube 112 is concentrically received within the support tube 30, which is concentrically received within the tube support 76. The riser tube 112 is supported for movement relative to the support tube 30 and the tube support 76. The riser tube 112 includes a cylindrical main tube 114 having a sliding seal 116 at its upper end. The sliding seal 116 includes an enlarged portion 118 supporting o-rings 120 for sliding movement within the support tube 30. More particularly, the support tube 30 remains in fluid communication with the riser tube 112 as the main body 52, including tube support 76, moves vertically between upper and lower limit positions 54 and 56. As may be appreciated, the riser tube 112 moves in a telescoping manner relative to the support tube 30 and the tube support 76.

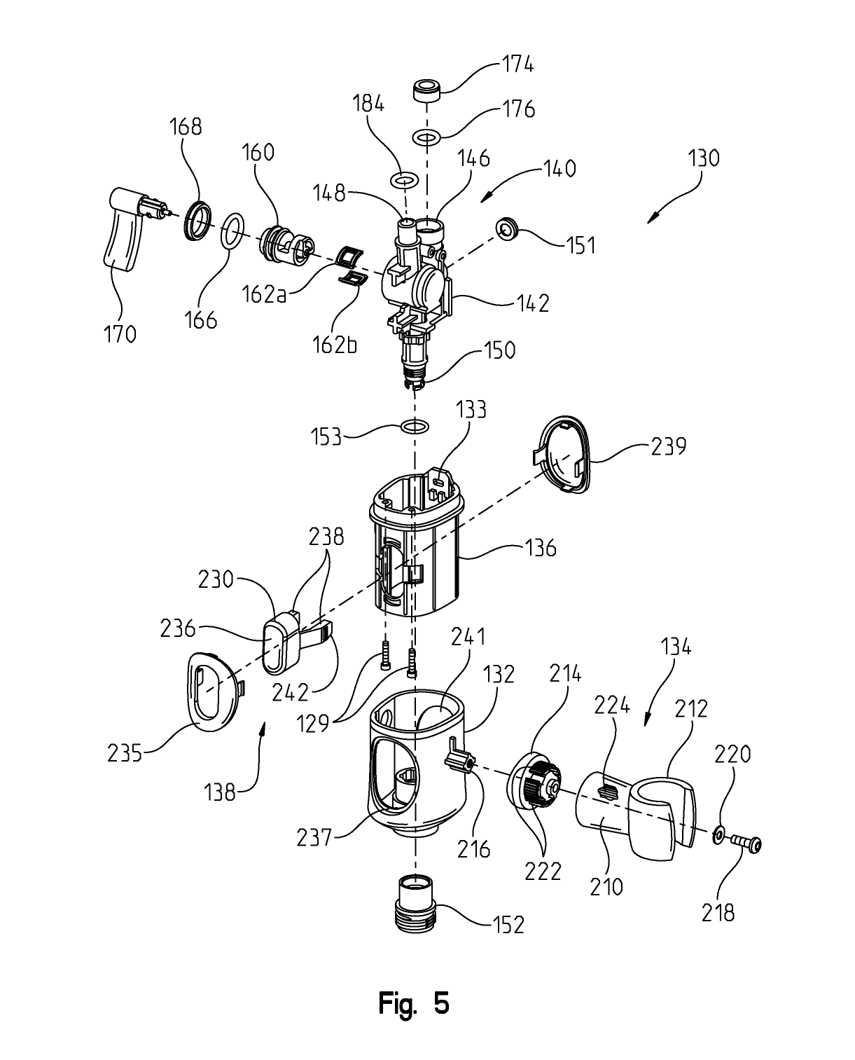

Referring now to FIGS. 4 and 5, the main body 52 further illustratively includes a user interface assembly 130 supported below the outer housing 68 for movement therewith. The user interface assembly 130 includes an outer housing 132 supporting a hand shower cradle 134, a handle support 136 supporting a brake user interface or release 138, and a diverter assembly 140. The outer housing 132 receives the handle support 136 which, in turn, receives the diverter assembly 140. Illustratively, the handle support 136 of the user interface assembly 130 is coupled to the outer housing 68 through conventional fasteners, such as screws 129. Additionally a retaining pin 131 may extend through the rear housing 72 and into an aperture 133 in the handle support 136.

The diverter assembly 140 illustratively includes a diverter body 142 including a chamber 144 in fluid communication with an inlet port 146, a first outlet port 148 and a second outlet port 150. A plug 151 is illustratively coupled to the diverter body 142 to seal chamber 144. A connector 152 is threadably coupled to the second outlet port 150 and secures together the outer housing 132, the handle support 136 and the diverter assembly 140.

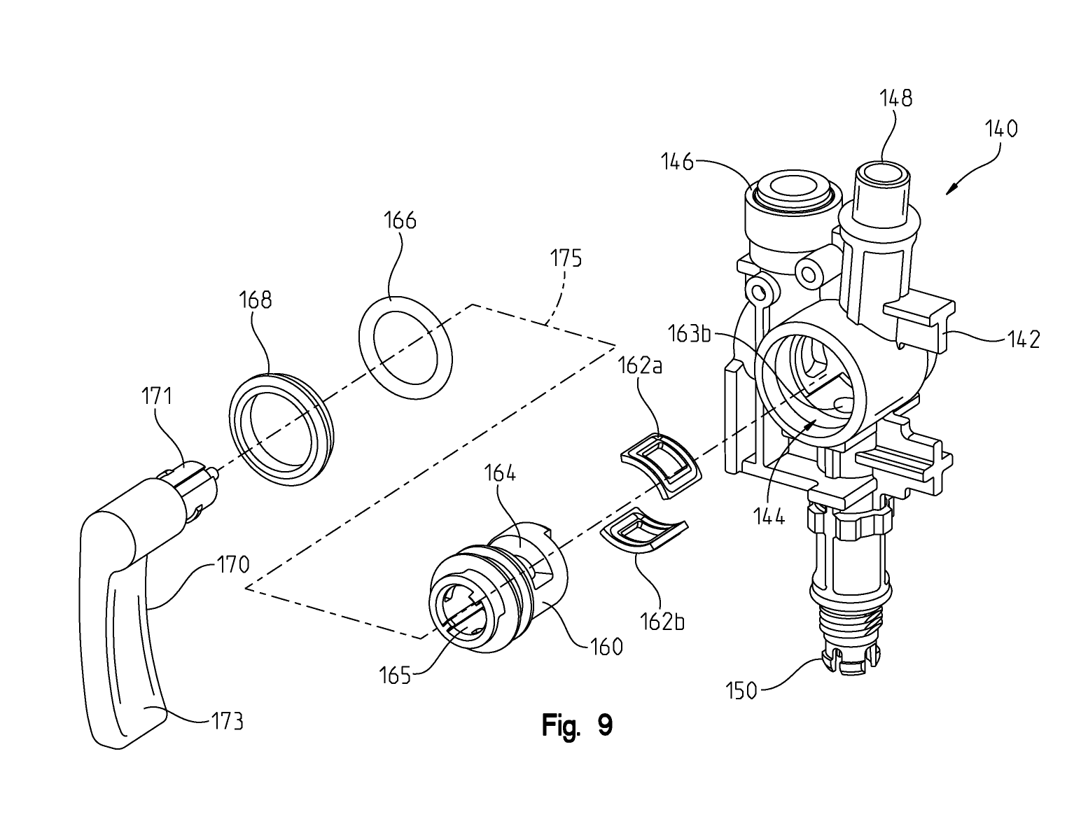

With respect to FIGS. 5, 9, 11A and 11B, a diverter core 160 is rotatably supported within the chamber 144 and cooperates with face seals 162a and 162b around apertures 163a and 163b within chamber 144. Apertures 163a and 163b are in fluid communication with first and second outlet ports 148 and 150, respectively. The diverter core 160 includes an arcuate channel 164 to provide selective communication between the inlet port 146 and the outlet ports 148 and 150. A recess 165 is formed in an end of the diverter core 160, and an outer o-ring 166 seals the core 160 within the chamber 144. A cap or retainer 168 secures the core 160 within the diverter body 142.

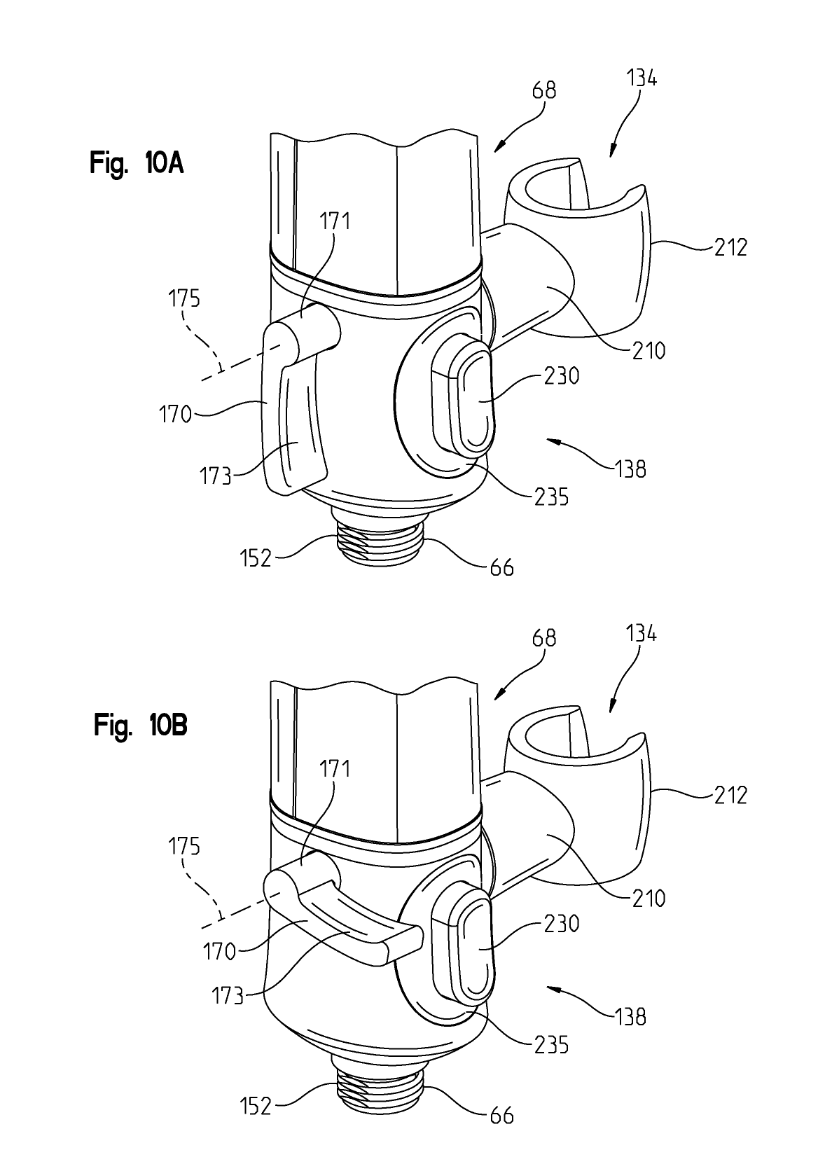

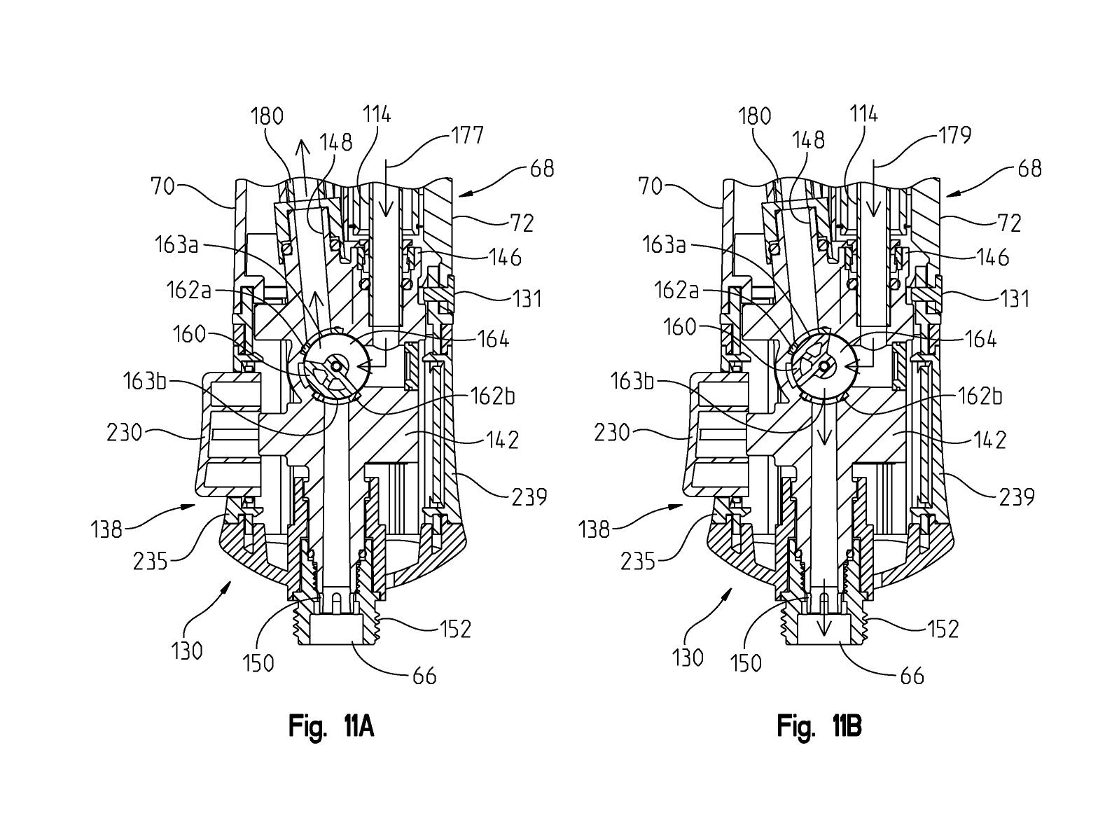

A lever 170 is coupled to the core 160 and is configured to permit a user to rotate the core 160 between a first position (FIGS. 10A and 11A) and a second position (FIGS. 10B and 11B). The lever 170 includes a base 171 received within the recess 165 of the diverter core 160. A handle or blade 173 rotates the base 171, and thereby the diverter core 160, around an axis 175 in response to user input.

In the first position of the lever 170 and the diverter core 160 as shown in FIGS. 10A and 11A, the channel 164 provides fluid communication between the inlet port 146 and the first outlet port 148 through aperture 163a. As such, the inlet 62 is in fluid communication with the first outlet 64 and the shower head 16. In the second position of the lever 170 and the diverter core 160 as shown in FIGS. 10B and 11B, the channel 164 provides fluid communication between the inlet port 146 and the second outlet port 150 through aperture 163b. As such, the inlet 62 is in fluid communication with the second outlet 66 and the hand shower 22.

With reference to FIGS. 4, 5, 7A and 7B, a lower end of the riser tube 112 is fluidly coupled to the inlet port 146 of the diverter body 142, illustratively through a conventional fluid connector 174, such as a John Guest fitting. The first outlet port 148 is fluidly coupled to a lower end of a shower outlet tube 178. The shower outlet tube 178 illustratively includes a cylindrical main tube 180, a lower fitting 182 and an upper fitting 186. The lower fitting 182 is illustratively threadably coupled to the outlet port 148 of the diverter body 142. The upper fitting 186 is fluidly coupled to an elbow connector 188 which, in turn, is coupled to the overhead shower head 16. More particularly, the upper fitting 186 is illustratively threadably coupled to the elbow connector 188. An o-ring 190 provides a seal between the fitting 186 and the connector 188.

The overhead shower head 16 may be of conventional design, including an outer shell 192 and a fitting 194. The fitting 194 is illustratively threadably coupled to the elbow connector 188. The shell 192 supports a plurality of fluid outlets or nozzles 196.

The second outlet port 150 is fluidly coupled to fluid connector 152 to define second outlet 66. The hand shower 22 includes a wand 200 including a spray head 202 coupled to a handle 204 (FIG. 2). A flexible outlet tube 206 fluidly couples the second outlet 66 to the wand 200. More particularly, a fluid connector 208 is threadably coupled to the fluid connector 152.

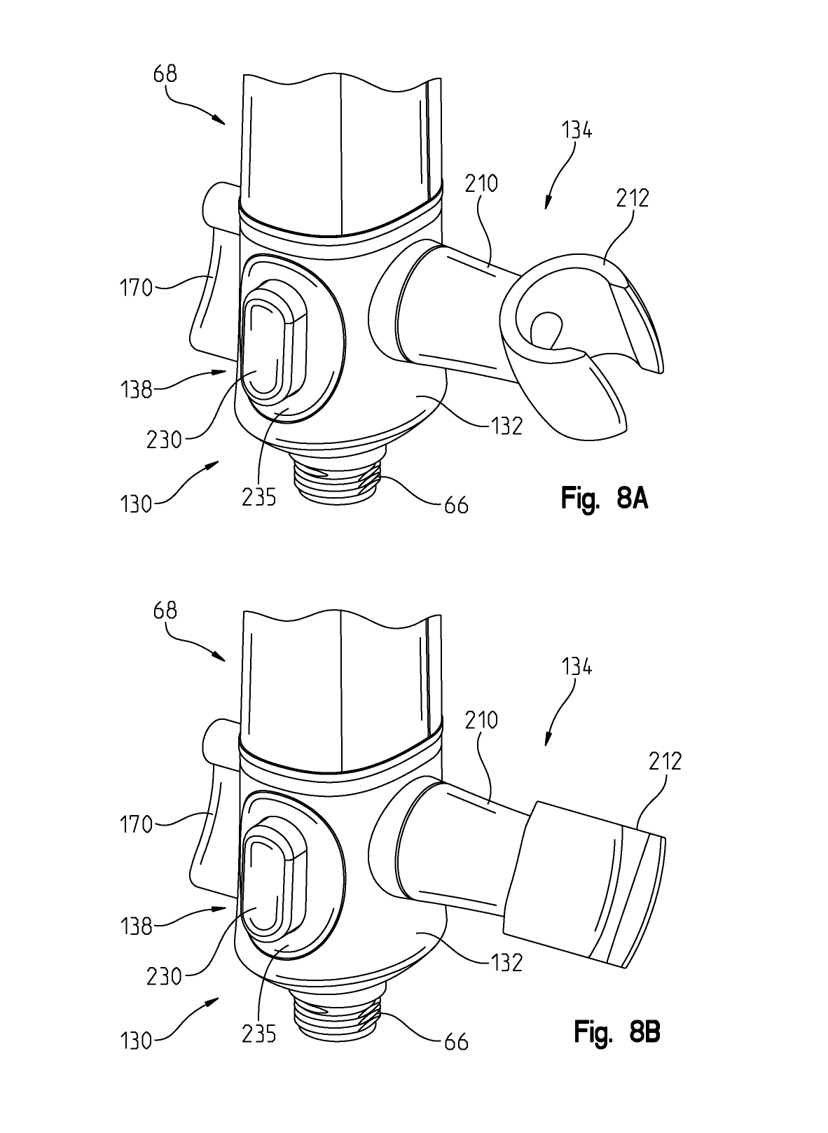

With reference to FIGS. 2, 5, 8A and 8B, the cradle 134 releasably supports the wand 200. The cradle 134 includes an arm 210 having a first end rotatably supported by the housing 132, and a second end supporting a clip 212. The clip 212 is configured to releasably secure the handle 204 of the wand 200. The arm 210 is rotatably supported by a detent base 214 mounted to a post 216 extending outwardly from the housing 132. A fastener, such as a screw 218 and washer 220 secures the base 214 to the post 216. The detent base 214 includes a plurality of recesses 222 to receive a fingers or pawls 224 supported within the arm 210. Each recess 222 is illustratively circumferentially spaced from an adjacent recess 222 by approximately 7.5 degrees. As such, cooperation between the fingers 224 and recesses 222 provides for rotational indexing of the cradle 134 in 7.5 degree increments.

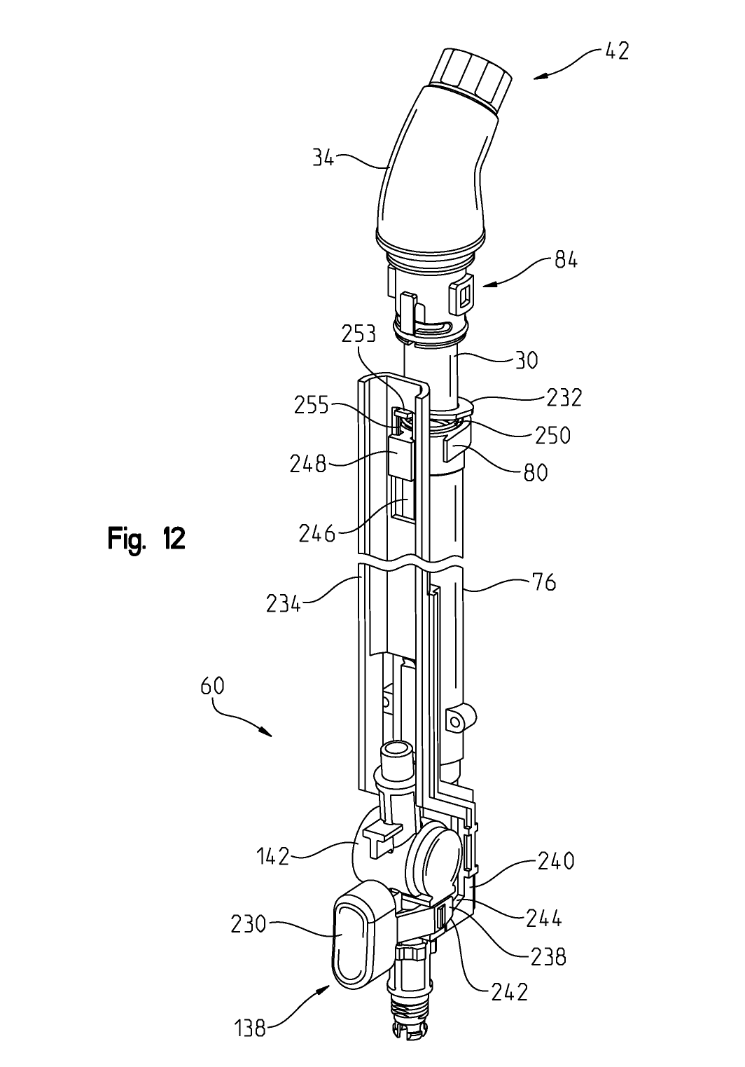

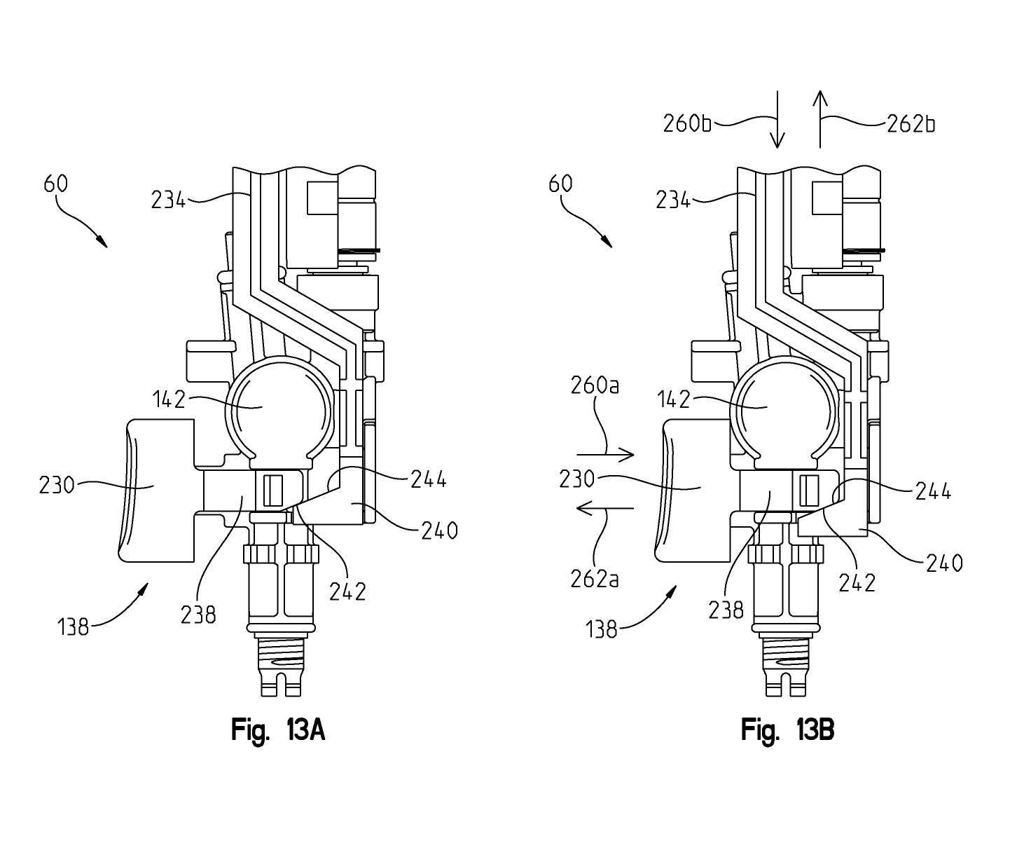

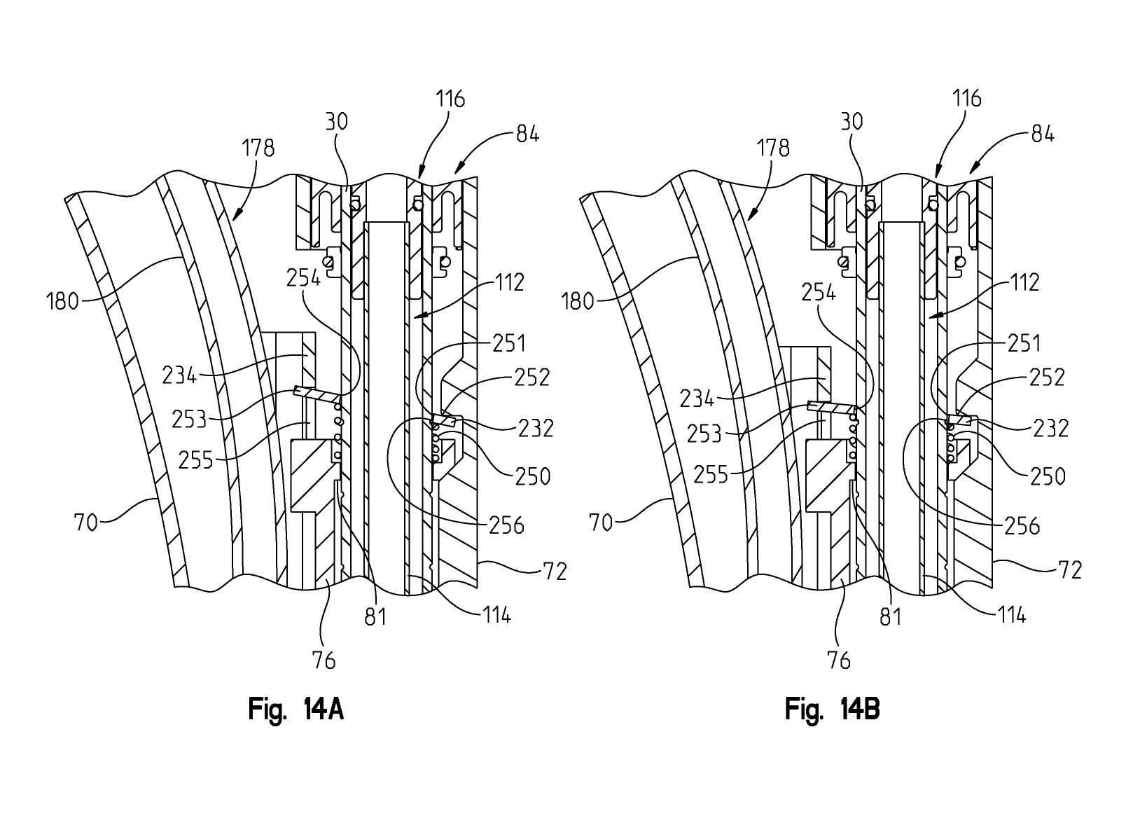

With reference to FIGS. 4 and 12-14B, the brake 60 illustratively includes brake user interface 138, illustratively a push button 230, operably coupled to a brake plate 232 through a release arm 234. A trim 235 is received within an opening 237 and surrounds button 230. A rear trim 239 is received within opening 241. The button 230 includes a pair of spaced apart fingers 238 that cooperate with fingers 240 at the lower end of the release arm 234. The button 230 is configured to cause the release arm 234 to move the brake plate 232 from a locked position securing the main body 52 to the support tube 30 (FIGS. 13A and 14A), to an unlocked position where the main body 52 is free to move vertically relative to the support tube 30 (FIGS. 13B and 14B). Each finger 238 of button 230 includes a downwardly facing inclined surface 242, while each finger 240 of release arm 234 includes an upwardly facing inclined surface 244 cooperating with the inclined surface 242. Cooperation between inclined surfaces 242 and 244 converts horizontal movement of button 230 to perpendicular vertical movement of release arm 234, and vice versa. A guide tab 248 of the tube support 76 is received within a slot 246 of the release arm 234 to guide movement of the release arm 234.

A spring 250 is positioned intermediate the tube support 76 and the brake plate 232. The brake plate 232 may be ring shaped as including a center opening 251 to receive the support tube 30. The brake plate 232 is configured to pivot about a pivot lip or ledge 252 (FIGS. 14A and 14B). In the illustrative embodiment, the brake plate 232 pivots clockwise in response to spring 250, and the brake plate 232 pivots counter-clockwise in response to movement of the release arm 234. A tab 253 illustratively extends outwardly from the brake plate 232 and is received within a slot 255 of the release arm 234.

When the brake plate 232 is pivoted clockwise as shown in FIG. 14A, an upper inner engagement edge 254 and a lower inner engagement edge 256 engages an outer surface of the support tube 30, thereby locking the main body 52 to the support tube 30. When the brake plate 232 is pivoted counter-clockwise as shown in FIG. 14B, the engagement edges 254 and 256 disengage from the outer surface of the support tube 30, thereby releasing the main body 52 for vertical movement along the support tube 30.

With reference to FIGS. 13A-14B, the push button 230 of user interface 138 is configured to engage a lower end of the release arm 234, thereby causing the release arm 234 to move downwardly and move the brake plate 232 from the locked position to the unlocked position. The spring 250 is provided to bias the brake plate 232 from the unlocked position to the locked position. As such, movement of button 230 inwardly in the direction of arrow 260a (FIG. 13B) causes movement of release arm 234 downwardly in the direction of arrow 260b. Similarly, movement of release arm 234 upwardly in the direction of arrow 262b (FIG. 13B) causes movement of button 230 outwardly in the direction of arrow 262a.

In operation, a user may vertically adjust the main body 52, and thereby the shower head 16 and the wand 200 of hand shower 22, along the support tube 30 by releasing the brake 60. The spring 250 biases the brake plate 232 into the locked position by pivoting the brake plate 232 about pivot ledge 252 such that engagement edges 254 and 256 engage the outer surface of support tube 30. The biasing of the brake plate 232 causes the tab 253 to move the release arm 234 upwardly. As the fingers 240 of the release arm 234 move upwardly, the inclined surfaces 244 force cooperating inclined surfaces 242 of the fingers 238 to move button 230 outwardly.

When a user depresses the push button 230, the inclined surfaces 242 of the fingers 238 cooperate with the inclined surfaces 242 of the fingers 240 of the release arm 234 to force the release arm 234 downwardly. The release arm 234 then moves the tab 253 downwardly, causing the brake plate 232 to pivot counter-clockwise about pivot ledge 252 such that the engagement edges 254 and 256 to disengage from the outer surface of the support tube 30. As such, the tube support 76 and housing 68 of the main body 52 are released from locking engagement with the support tube 30. More particularly, the support tube 30 is free for vertical movement within the opening 251 of the brake plate 232. As such, the tube support 76 and the housing 68 of the main body 52 are free for vertical movement relative to the support tube 30.

Once unlocked, the main body 52 may move vertically between upper and lower limit positions 54 and 56. The upper limit position 54 is illustratively defined by engagement between the flange 108 of the tube guide 84 and the elbow 34. The lower limit position 56 is illustratively defined between the snap ring 38 and the lip 81 of the tube support 76. As may be appreciated, vertical movement of the main body 52 causes similar movement of the overhead shower head 16 and the hand shower wand 200. The user interface 130 also moves with the main body 52 such that a user may position the diverter valve lever 170 and the brake release push button 130 in a desired vertical position.

A user may change water flow output from between the overhead shower head 16 and the hand shower 22 by rotating the diverter valve lever 170. In the first position (FIGS. 10A and 11A), water is directed to the shower head 16. By rotating the lever 170 to a second position (FIGS. 10B and 11B), water is instead directed to the hand shower 22.

Although the invention has been described in detail with reference to certain preferred embodiments, variations and modifications exist within the spirit and scope of the invention as described and defined in the following claims.

1. An adjustable shower system comprising:
a support tube configured to be fluidly coupled to a shower arm;
a main body supported for sliding movement along the support tube, the main body including an inlet, a first outlet and a second outlet;
a showerhead fluidly coupled to the first outlet;
a hand shower including a flexible outlet tube fluidly coupled to the second outlet;
a diverter valve supported by the main body and configured to provide selective fluid communication between the inlet and the first outlet, and the inlet and the second outlet; and
the main body including a riser tube in fluid communication with the support tube, the riser tube being positioned in a telescoping arrangement with the support tube and in fluid communication with the inlet and the diverter valve.

2. The adjustable shower system of claim 1, further comprising a brake configured to releasably secure the main body at a vertical position along the support tube.

3. The adjustable shower system of claim 2, wherein the brake includes a user interface, a brake plate, and a release arm operably coupling the user interface and the brake plate, the user interface configured to cause the release arm to move the brake plate from a locked position secured to the support tube to an unlocked position released from the support tube.

4. The adjustable shower system of claim 3, wherein the user interface includes a push button configured to engage a lower end of the release arm, thereby causing the release arm to move downwardly and move the brake plate from the locked position to the unlocked position, and a spring to move the brake plate from the unlocked position to the locked position.

5. The adjustable shower system of claim 4, wherein the brake plate includes engagement edges defining an opening, the support tube configured to slidably move through the opening in the unlocked position, and the engagement edges configured to engage the support tube in the locked position.

6. The adjustable shower system of claim 1, further comprising a cradle supported by the main body and configured to releasably support the hand shower.

7. The adjustable shower system of claim 6, wherein the cradle is rotatably supported by the main body.

8. The adjustable shower system of claim 1, wherein the diverter valve includes a body supported intermediate the inlet and the first and second outlets, a lever arm, and a diverter core coupled to the lever arm to rotate the core between a first position and a second position, the inlet in fluid communication with the first outlet in the first position, and the inlet in fluid communication with the second outlet in the second position.

9. The adjustable shower system of claim 1, wherein the riser tube is telescopingly received within the support tube, and the inlet includes slidable seals positioned intermediate the riser tube and the support tube.

10. An adjustable shower system comprising:
a support tube configured to be fluidly coupled to a shower arm;
a riser tube fluidly coupled to the support tube and supported for sliding movement along the support tube;
a showerhead fluidly coupled to the riser tube; and
a brake configured to releasably secure the riser tube at one of a plurality of vertical positions along the support tube, wherein the brake includes a user interface, a brake plate, and a release arm operably coupling the user interface and the brake plate, the user interface configured to cause the release arm to move the brake plate from a locked position secured to the support tube to an unlocked position released from the support tube.

11. The adjustable shower system of claim 10, wherein the riser tube is received within a main body including an inlet, a first outlet and a second outlet, the showerhead being fluidly coupled to the first outlet.

12. The adjustable shower system of claim 11, further comprising a hand shower including a flexible outlet tube fluidly coupled to the second outlet, and a diverter valve supported by the main body and configured to provide selective fluid communication between the inlet and the first outlet, and the inlet and the second outlet.

13. The adjustable shower system of claim 12, further comprising a cradle rotatably supported by the main body and configured to releasably support the hand shower.

14. The adjustable shower system of claim 12, wherein the diverter valve includes a body supported intermediate the inlet and the first and second outlets, a lever arm, and a diverter core coupled to the lever arm to rotate the core between a first position and a second position, the inlet in fluid communication with the first outlet in the first position, and the inlet in fluid communication with the second outlet in the second position.

15. The adjustable shower system of claim 12, wherein the riser tube is positioned in a telescoping arrangement with the support tube and in fluid communication with the inlet and the diverter valve.

16. The adjustable shower system of claim 15, wherein the riser tube is telescopingly received within the support tube, and the inlet includes slidable seals positioned intermediate the riser tube and the support tube.

17. The adjustable shower system of claim 10, wherein the user interface includes a push button configured to engage a lower end of the release arm, thereby causing the release arm to move downwardly and move the brake plate from the locked position to the unlocked position, and a spring to move the brake plate from the unlocked position to the locked position.

18. The adjustable shower system of claim 17, wherein the brake plate includes engagement edges defining an opening, the support tube configured to slidably move through the opening in the unlocked position, and the engagement edges configured to engage the support tube in the locked position.

19. The adjustable shower system of claim 18, wherein the brake plate is supported for pivoting movement between the unlocked position and the locked position.

20. An adjustable shower system comprising:
a support tube configured to be fluidly coupled to a shower arm;
a main body supported for sliding movement along the support tube;
a showerhead fluidly coupled to the main body;
a hand shower including a flexible outlet tube fluidly coupled to the main body;
a cradle supported by the main body and configured to releasably support the hand shower; and
a brake configured to releasably secure the main body at one of a plurality of vertical positions along the support tube.

21. The adjustable shower system of claim 20, wherein the brake includes a user interface, a brake plate, and a release arm operably coupling the user interface and the brake plate, the user interface configured to cause the release arm to move the brake plate from a locked position secured to the support tube to an unlocked position released from the support tube.

22. The adjustable shower system of claim 21, wherein the user interface includes a push button configured to engage a lower end of the release arm, thereby causing the release arm to move downwardly and move the brake plate from the locked position to the unlocked position, and a spring to move the brake plate from the unlocked position to the locked position.

23. The adjustable shower system of claim 22, wherein the brake plate includes engagement edges defining an opening, the support tube configured to slidably move through the opening in the unlocked position, and the engagement edges configured to engage the support tube in the locked position.

24. The adjustable shower system of claim 23, wherein the brake plate is supported for pivoting movement between the locked position and the unlocked position.

25. The adjustable shower system of claim 20, further comprising a diverter valve supported by the main body and configured to provide selective fluid communication between the inlet and the first outlet and the inlet and the second outlet.

26. The adjustable shower system of claim 25, wherein the diverter valve includes a body supported intermediate the inlet and the first and second outlets, a lever arm, and a diverter core coupled to the lever arm to rotate the core between a first position and a second position, the inlet in fluid communication with the first outlet in the first position, and the inlet in fluid communication with the second outlet in the second position.

27. The adjustable shower system of claim 25, wherein the main body includes a riser tube in fluid communication with the support tube, the riser tube being positioned in a telescoping arrangement with the support tube and in fluid communication with the inlet and the diverter valve.

28. The adjustable shower system of claim 27, wherein the riser tube is telescopingly received within the support tube, and the inlet includes slidable seals positioned intermediate the riser tube and the support tube.
